(19) United States
(12) Patent Application Publication
(10) Pub. No.: US 2025/0383819 A1
(43) Pub. Date: Dec. 18, 2025

(54) CHANGE OPEN VIRTUAL BLOCK FLOW FOR A SYSTEM

(71) Applicant: Micron Technology, Inc., Boise, ID (US)

(72) Inventors: Xiao Wang, Shanghai (CN); Xiaolai Zhu, Shanghai (CN); Xing Wang, Shanghai (CN)

(21) Appl. No.: 19/232,691

(22) Filed: Jun. 9, 2025

Related U.S. Application Data
(60) Provisional application No. 63/659,770, filed on Jun. 13, 2024.

(51) Int. Cl. G06F 3/06

(52) U.S. Cl. CPC G06F 3/0659; G06F 3/0604; G06F 3/0608; G06F 3/0652; G06F 3/0685

(57) ABSTRACT

Methods, systems, and devices for a change open virtual block flow for a system are described. The system may select a first virtual block from a first set of virtual blocks and select a second virtual block from the first set in response to first data stored in memory corresponding to the first virtual block satisfying a threshold. The system may write second data to memory corresponding to the second virtual block in response to selecting the second virtual block from the first set and during an idle period, select a third virtual block from a second set of virtual blocks different than the first set. Upon selecting the third virtual block, the system may erase third data stored in memory corresponding to the third virtual block and update, in response to erasing the third data, the first set to include the third virtual block.

### CROSS REFERENCE

The present application for patent claims priority to U.S. Patent Application No. 63/659,770 by Wang et al., entitled “CHANGE OPEN VIRTUAL BLOCK FLOW FOR A SYSTEM,” filed Jun. 13, 2024, which is assigned to the assignee hereof, and which is expressly incorporated by reference in its entirety herein.

### TECHNICAL FIELD

The following relates to one or more systems for memory, including a change open virtual block flow for a system.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states if disconnected from an external power source.

### BRIEF DESCRIPTION OF THE DRAWINGS

FIG. 1 shows an example of a system that supports a change open virtual block flow for a system in accordance with examples as disclosed herein.

FIG. 2 shows an example of a change open virtual block flow that supports change open virtual block flow for a system in accordance with examples as disclosed herein.

FIG. 3 shows an example of a flow diagram that supports a change open virtual block flow for a system in accordance with examples as disclosed herein.

FIG. 4 shows a block diagram of a system that supports a change open virtual block flow for a system in accordance with examples as disclosed herein.

FIGS. 5 and 6 show flowcharts illustrating a method or methods that support a change open virtual block flow for a system in accordance with examples as disclosed herein.

### DETAILED DESCRIPTION

During a write operation (e.g., host write, garbage collection write), the host system may detect that a first virtual block is full and select a second virtual block for the write operation. To change virtual blocks, the host system may undergo a change open virtual block flow. During the change open virtual block flow, the host system may block write commands for a period of time to perform the operations necessary to change to the second virtual block. The operations may include, at least, performing a redundant array of independent nodes (RAIN) flush on the second virtual block, selecting the second virtual block from an invalid virtual block pool, performing block erase on the second virtual block, and flushing system information corresponding to the second virtual block. However, performing such operations may be time consuming resulting in long write latency, among other challenges.

As described herein, the host system may perform a change open block flow with reduced write latency compared to other methods. During a write operation, the host system may detect that a first virtual block is full. Upon detecting that the first virtual block is full, the host system may perform a change open block flow. Performing the change open block flow may include performing a RAIN flush on the first virtual block, selecting a second virtual block from an open virtual block pool, and flushing system information corresponding to the second virtual block. After this, the host system may perform the write operation using the second virtual block. The open virtual block pool may include one or more virtual blocks that are open and thus, unlike other methods, the host system may not perform a block erase operation on the second virtual block prior to using the second virtual block for the write operation. During one or more idle periods, the host system may perform operations to replenish the open virtual block pool. For example, during one or more idle periods, the memory system may select a third virtual block from an invalid virtual block pool and perform a block erase operation on the third virtual block before placing the third virtual block in the open virtual block pool.

In addition to applicability in memory systems as described herein, the change open virtual block flow for the system may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by reducing write latency, which may improve user experience, among other benefits.

Features of the disclosure are illustrated and described in the context of systems, devices, and circuits. Features of the disclosure are further illustrated and described in the context of a change open virtual block flow, a flow diagram, and flowcharts.

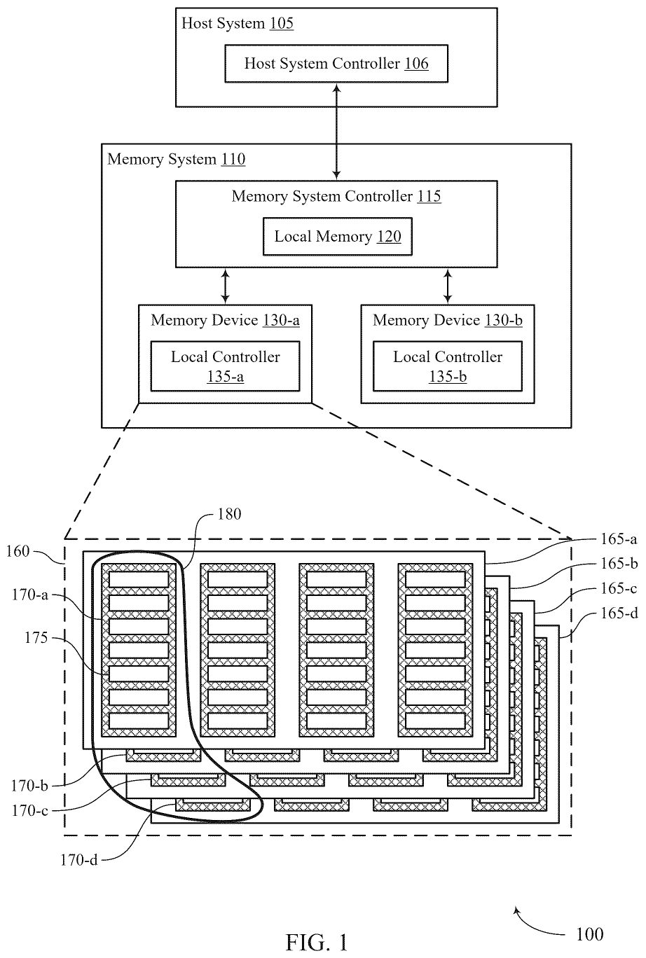

FIG. 1 shows an example of a system 100 that supports a change open virtual block flow for a system in accordance with examples as disclosed herein. The system 100 includes a host system 105 coupled with a memory system 110. The system 100 may be included in a computing device such as a desktop computer, a laptop computer, a network server, a mobile device, a vehicle, an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on the same die, within the same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in the same page 175 may share (e.g., be coupled with) a common word line, and memory cells in the same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

In some cases, to update some data within a block 170 while retaining other data within the block 170, the memory device 130 may copy the data to be retained to a new block 170 and write the updated data to one or more remaining pages of the new block 170. The memory device 130 (e.g., the local controller 135) or the memory system controller 115 may mark or otherwise designate the data that remains in the old block 170 as invalid or obsolete and may update a logical-to-physical (L2P) mapping table to associate the logical address (e.g., LBA) for the data with the new, valid block 170 rather than the old, invalid block 170. In some cases, such copying and remapping may be performed instead of erasing and rewriting the entire old block 170 due to latency or wearout considerations, for example. In some cases, one or more copies of an L2P mapping table may be stored within the memory cells of the memory device 130 (e.g., within one or more blocks 170 or planes 165) for use (e.g., reference and updating) by the local controller 135 or memory system controller 115. In some cases, L2P mapping tables may be maintained and data may be marked as valid or invalid at the page level of granularity, and a page 175 may contain valid data, invalid data, or no data. Invalid data may be data that is outdated, which may be due to a more recent or updated version of the data being stored in a different page 175 of the memory device 130. Invalid data may have been previously programmed to the invalid page 175 but may no longer be associated with a valid logical address, such as a logical address referenced by the host system 105. Valid data may be the most recent version of such data being stored on the memory device 130. A page 175 that includes no data may be a page 175 that has never been written to or that has been erased.

In some cases, a memory system controller 115 or a local controller 135 may perform operations (e.g., as part of one or more media management algorithms) for a memory device 130, such as wear leveling, background refresh, garbage collection, scrub, block scans, health monitoring, or others, or any combination thereof. For example, within a memory device 130, a block 170 may have some pages 175 containing valid data and some pages 175 containing invalid data. To avoid waiting for all of the pages 175 in the block 170 to have invalid data in order to erase and reuse the block 170, an algorithm referred to as “garbage collection” may be invoked to allow the block 170 to be erased and released as a free block for subsequent write operations. Garbage collection may refer to a set of media management operations that include, for example, selecting a block 170 that contains valid and invalid data, selecting pages 175 in the block that contain valid data, copying the valid data from the selected pages 175 to new locations (e.g., free pages 175 in another block 170), marking the data in the previously selected pages 175 as invalid, and erasing the selected block 170. As a result, the quantity of blocks 170 that have been erased may be increased such that more blocks 170 are available to store subsequent data (e.g., data subsequently received from the host system 105).

As described herein, the system 100 may perform the change open block flow with reduced write latency compared to other methods. In some examples, the host system 105 may select a first virtual block from a first set of virtual blocks. The first set of virtual blocks may include the first virtual block and a second virtual block. Further, the host system 105 may select the second virtual block from the first set of virtual blocks in response to first data stored in memory corresponding to the first virtual block satisfying a threshold. Further, the memory system 110 may write second data to memory corresponding to the second virtual block in response to the host system 105 selecting the second virtual block from the first set of virtual blocks and during an idle period, the host system 105 may select a third virtual block from a second set of virtual blocks different than the first set of virtual blocks. Upon the host system 105 selecting the third virtual block, the memory system 110 may erase third data stored in memory corresponding to the third virtual block and the host system 105 may update, in response to the memory system 110 erasing the third data, the first set of virtual blocks to include the third virtual block. In some examples, the methods as described herein may be perform by the host system controller 106 and/or the memory system controller 115.

The system 100 may include any quantity of non-transitory computer readable media that support a change open virtual block flow for a system. For example, the host system 105 (e.g., a host system controller 106), the memory system 110 (e.g., a memory system controller 115), or a memory device 130 (e.g., a local controller 135), or any combination thereof may include or otherwise may access one or more non-transitory computer readable media storing instructions (e.g., firmware, logic, code) for performing the functions ascribed herein to the host system 105, the memory system 110, or the memory device 130, or combination thereof. For example, such instructions, if executed by the host system 105 (e.g., by a host system controller 106), by the memory system 110 (e.g., by a memory system controller 115), or by a memory device 130 (e.g., by a local controller 135), may cause the host system 105, the memory system 110, or the memory device 130 to perform associated functions as described herein.

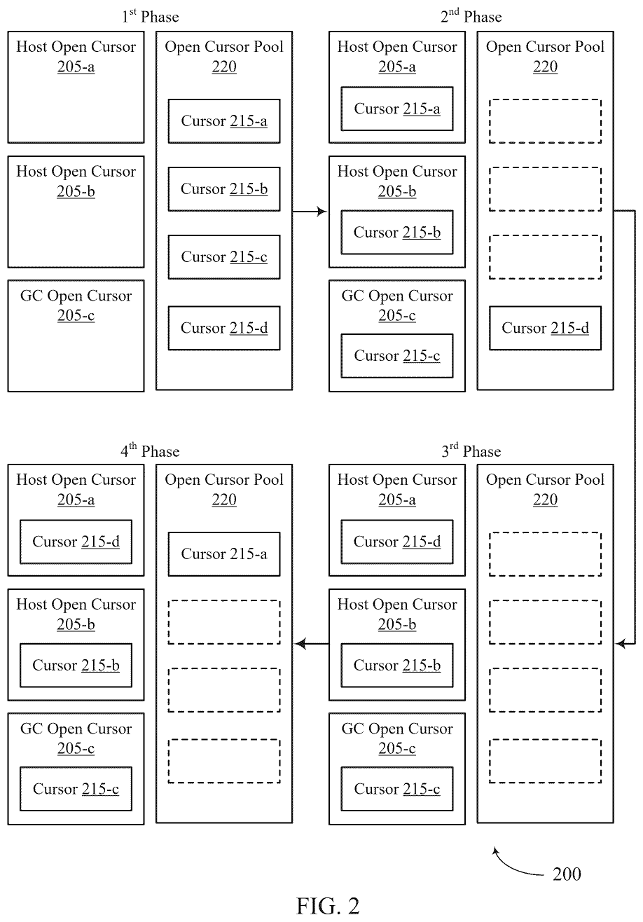

FIG. 2 shows an example of a change open virtual block flow 200 that supports a change open virtual block flow for a system in accordance with examples as disclosed herein. In some examples, the change open virtual block flow 200 may be implemented by aspects of a system 100. For example, the change open virtual block flow 200 may be implemented by a host system 105, or more specifically a host system controller 106, as described with reference to FIG. 1.

In some examples, a host system may perform a write operation on a memory system. During the write operation, the host system may instruct the memory system (e.g., via a write command) to of write data to a virtual block memory cells which may correspond to memory of the memory system (e.g., one or more physical blocks of memory cells). Once the memory system writes a threshold amount of data to the virtual block of memory cells, the host system may perform the change open virtual block flow 200 to select a new virtual block of memory cells to write to.

As shown in FIG. 2, the host system may be configured with one or more open cursors 205. In some examples, each open cursor 205 may be associated with a respective operation. For example, the host system may be configured with an open cursor 205-a, an open cursor 205-b, and an open cursor 205-c. The open cursor 205-a and the open cursor 205-b may correspond to host write operations, while the open cursor 205-c may correspond to garbage collection operations. Further, the host system may be configured with an open cursor pool 220. The open cursor pool 220 may include a set of cursors 215 and each cursor 215 of the set may be mapped to a respective candidate open virtual block of memory cells. In some examples, a quantity of cursors 215 included in the open cursor pool 220 may be greater than a quantity of open cursors 205. For example, the quantity of cursors 215 included in the open cursor pool 220 may be equal to the quantity of open cursors 205 plus one. In the example of FIG. 2, the quantity of open cursors 205 may be equal to three and the quantity of the cursors 215 included in the open cursor pool 220 may be equal to four. The four cursors 215 included in the open cursor pool 220 may include a cursor 215-a, a cursor 215-b, a cursor 215-c, and a cursor 215-d.

In a 1st phase of the change open virtual block flow 200, each of the open cursors 205 may be empty and the open cursor pool 220 may include a set of four candidate cursors 215 (e.g., the cursor 215-a, the cursor 215-b, the cursor 215-c, and the cursor 215-d). At this time, the cursor 215-a may be mapped to a first virtual block of memory cells, the cursor 215-b may be mapped to a second virtual block of memory cells, the cursor 215-c may be mapped to a third virtual block of memory cells, and the cursor 215-d may be mapped to a fourth virtual block of memory cells. In some examples, memory associated with the first virtual block of memory cells, the second virtual block of memory, the third virtual block of memory cells, and the fourth virtual block of memory cells may include no data or data below a first threshold amount of data.

In a 2nd phase of the change open virtual block flow 200, the host system may select a cursor 215 from the open cursor pool 220 for each of the open cursors 205. For example, as shown in FIG. 2, the host system may select the cursor 215-a for the open cursor 205-a, the cursor 215-b for the open cursor 205-b, and the cursor 215-c for the open cursor 205-c. As described above, the quantity of cursors 215 included in the open cursor pool 220 may be greater than the quantity of open cursor 205. Thus, one or more cursors 215 (e.g., the cursor 215-d) may remain in the open cursor pool 220.

Upon selecting the cursors 215 from the open cursor pool 220, the host system may perform one or more operations. For example, the host system may instruct the memory system to write data to memory corresponding to the cursor 215-a (e.g., memory corresponding to the first virtual block of memory cells). After some duration, the host system may detect that the cursor 215-a is full. That is, the host system may detect that an amount of data written to the memory corresponding to the cursor 215-a may meet or exceed a second threshold amount of data. If the host system identifies that a cursor 215 is full, the host system may select a new cursor 215 from the open cursor pool 220.

For example, in a 3rd phase of the change open virtual block flow 200, the host system may select the cursor 215-d from the open cursor pool 220 to replace the cursor 215-a. Upon selecting the cursor 215, the host system may remove the cursor 215-a and at this time, the open cursor pool may be empty. The host system may then perform access operations using the cursor 215-d (or the fourth virtual block of memory cells).

In some examples, during idle periods (e.g., periods of time that the host system may not perform operations), the host system may replenish the open cursor pool 220. For example, in a 4th phase of the change open virtual block flow 200, the host system may select a fifth virtual block of memory cells (e.g., a virtual block of memory cells that corresponds to memory that includes invalid data) and erase the invalid data stored at the memory corresponding to the fifth virtual block of memory cells. The host system may then assign the fifth virtual block of memory cells to the cursor 215-a and place the cursor 215-a back in the open cursor pool 220. If the host system detects that memory corresponding to the cursor 215-b, the cursor 215-c, or the cursor 215-d is full, the host system may select the cursor 215-a from the open cursor pool 220 to replace the cursor 215-b, the cursor 215-c, or the cursor 215-d. Unlike other methods, the host system may immediately select a cursor 215 from the open cursor pool 220 and use the selected cursor 215 for write operations which may reduce write latency at the host system.

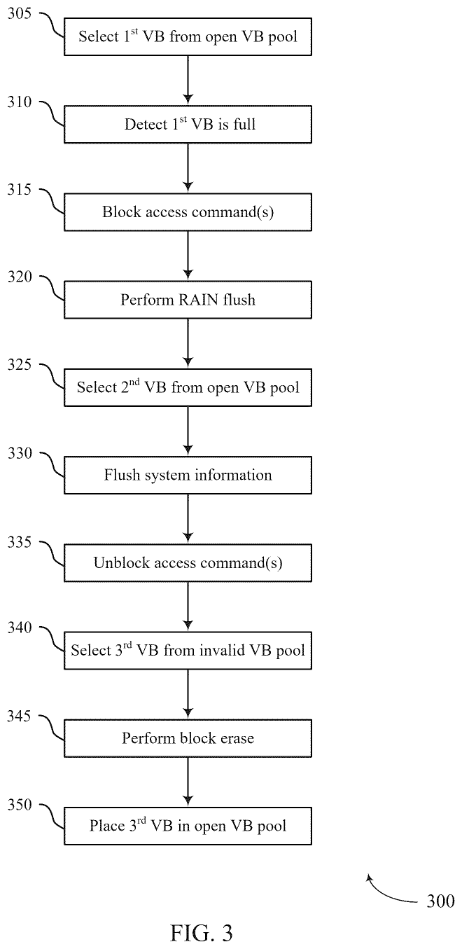

FIG. 3 shows an example of a flow diagram 300 that supports a change open virtual block flow for a system in accordance with examples as disclosed herein. In some examples, the flow diagram 300 may be implemented by aspects of a system 100. For example, the flow diagram 300 may be implemented by a host system 105 or a memory system 110 as described with reference to FIG. 1.

At 305, the host system (or firmware of the host system) may select a first virtual block from a first set of virtual blocks. In some examples, the first set of virtual blocks may be known as an open virtual block pool and may include the first virtual block and a second virtual block. The open virtual block pool may include virtual blocks that correspond to memory of a memory system that include no data or data below a first threshold (e.g., virtual blocks whose corresponding memory underwent a previous block erase operation). Further, in some examples, the open virtual block pool may be shared by multiple types of host cursors (e.g., host write cursors and garbage collection cursors).

At 310, the host system (or the firmware of the host system) may detect that the first virtual block (e.g., of a host cursor or a garbage collection cursor) is full. That is, the host system may detect that first data stored in memory corresponding to the first virtual block satisfies a second threshold. In some examples, the host system may detect the first virtual block is full in response to signaling from the memory system indicating that the first virtual block is full.

At 315, the host system (or the firmware of the host system) may block one or more access operations (e.g., write operations or garbage collection operations) in response to detecting that the first virtual block is full. For example, the host system may refrain from instructing the memory system to write data to the memory corresponding to the first virtual block. In other words, the host system may set flow control to block current writes (e.g., host write or GC writes). In response, the memory system may not perform any access operations (e.g., write operations or garbage collection operations) on the memory corresponding to the first virtual block.

At 320, the host system (or the firmware of the host system) may instruct the memory system to perform a redundant array of independent nodes (RAIN) flush. To perform the RAIN flush, the memory system may flush parity information corresponding to the first data to the memory corresponding to the first virtual block. That is, the memory system may fill the remaining space of the memory corresponding to the first virtual block with the parity information.

At 325, the host system (or the firmware of the host system) may select the second virtual block from the first set of virtual blocks in response to the host system detecting that the first virtual block is full.

At 330, the host system (or the firmware of the host system) may flush system information associated with the second virtual block in response to selecting the second virtual block.

At 335, the host system (or the firmware of the host system) may resume the one or more operations (e.g., write operations or garbage collection operations) in response to selecting the second virtual block. That is, the host system may instruct the memory system to write data to memory corresponding to the second virtual block. In other words, the host system may clear flow control and writes (e.g., host writes or GC writes) may continue. In response, the memory system may perform the one or more access operations (e.g., write operations or garbage collection operations) on the memory corresponding to the second virtual block.

At 340, the host system (or the firmware of the host system) may select a third virtual block from a second set of virtual blocks different from the first set of virtual blocks. In some examples, the second set of virtual blocks may be known as the invalid virtual block pool. The invalid virtual block pool may include virtual blocks whose corresponding memory of the memory system include invalid data (or expired data).

At 345, the host system (or the firmware of the host system) may instruct the memory system to perform a block erase operation on the third virtual block. In response, the memory system may erase data from memory corresponding to the third virtual block.

At 350, the host system may update the first set of virtual blocks to include the third virtual block. That is, the host system may add the third virtual block to the open virtual block pool. In some examples, steps 340 through 350 may be performed during an idle time at the host system. In some examples, the host system may repeat steps 310 through 350 upon detecting that another virtual block of a cursor is full. During steps 315 through 335, the host system may block or pause access operations (e.g., write operations). Using other methods, the host system may block access operations for a longer time period resulting in long write latency.

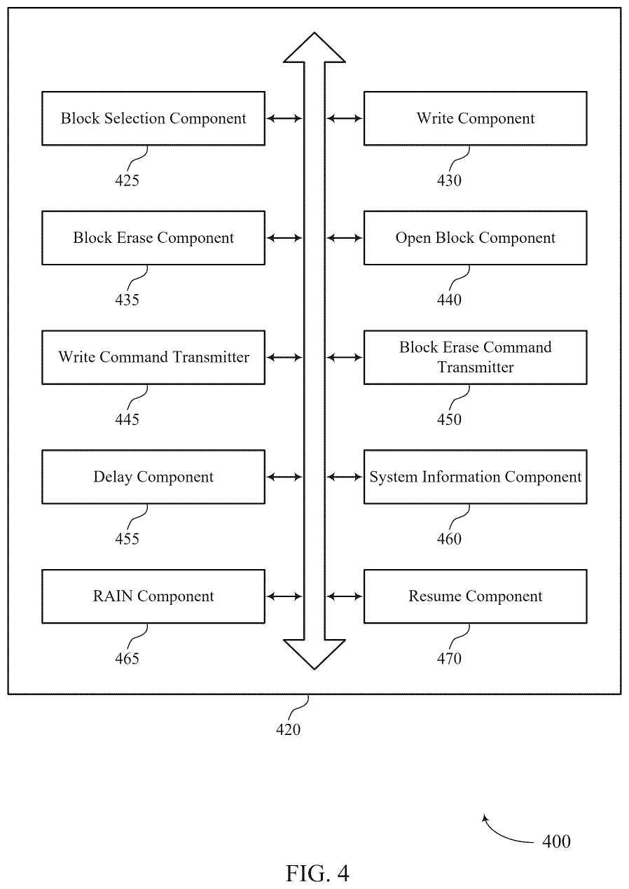

FIG. 4 shows a block diagram 400 of a system 420 that supports a change open virtual block flow in accordance with examples as disclosed herein. The system 420 may be an example of aspects of a host system or a memory system as described with reference to FIGS. 1 through 3. The system 420, or various components thereof, may be an example of means for performing various aspects of a change open virtual block flow for a system as described herein. For example, the system 420 may include a block selection component 425, a write component 430, a block erase component 435, an open block component 440, a write command transmitter 445, a block erase command transmitter 450, a delay component 455, a system information component 460, a RAIN component 465, a resume component 470, or any combination thereof. Each of these components, or components of subcomponents thereof (e.g., one or more processors, one or more memories), may communicate, directly or indirectly, with one another (e.g., via one or more buses).

The block selection component 425 may be configured as or otherwise support a means for selecting a first virtual block from a first plurality of virtual blocks, the first plurality of virtual blocks including the first virtual block and a second virtual block. In some examples, the block selection component 425 may be configured as or otherwise support a means for selecting the second virtual block from the first plurality of virtual blocks based at least in part on first data stored in memory corresponding to the first virtual block satisfying a threshold. The write component 430 may be configured as or otherwise support a means for writing second data to memory corresponding to the second virtual block based at least in part on selecting the second virtual block from the first plurality of virtual blocks. In some examples, the block selection component 425 may be configured as or otherwise support a means for selecting a third virtual block from a second plurality of virtual blocks different than the first plurality of virtual blocks. The block erase component 435 may be configured as or otherwise support a means for erasing third data stored in memory corresponding to the third virtual block based at least in part on selecting the third virtual block from the second plurality of virtual blocks. The open block component 440 may be configured as or otherwise support a means for updating, based at least in part on erasing the third data, the first plurality of virtual blocks to further include the third virtual block.

In some examples, the delay component 455 may be configured as or otherwise support a means for delaying one or more access operations based at least in part on the first data stored in the memory corresponding to the first virtual block satisfying the threshold.

In some examples, the resume component 470 may be configured as or otherwise support a means for resuming the one or more access operations based at least in part on selecting the second virtual block from the first plurality of virtual blocks, where writing the second data to the memory corresponding to the second virtual block is based at least in part on resuming the one or more access operations.

In some examples, to support erasing the third data, the block erase component 435 may be configured as or otherwise support a means for erasing the third data stored in the memory corresponding to the third virtual block during an idle time associated with the system.

In some examples, the system information component 460 may be configured as or otherwise support a means for flushing system information associated with the second virtual block based at least in part on selecting the second virtual block from the first plurality of virtual blocks.

In some examples, the RAIN component 465 may be configured as or otherwise support a means for flushing parity information associated with the first data to the memory corresponding to the first virtual block based at least in part on the first data stored in the memory corresponding to the first virtual block satisfying the threshold.

In some examples, the open block component 440 may be configured as or otherwise support a means for determining a first quantity of virtual blocks for host system write operations. In some examples, the open block component 440 may be configured as or otherwise support a means for determining a second quantity of virtual blocks for garbage collection operations.

In some examples, a third quantity of virtual blocks is greater than a sum of the first quantity of virtual blocks and the second quantity of virtual blocks. In some examples, the first plurality of virtual blocks includes the third quantity of virtual blocks.

In some examples, the block selection component 425 may be configured as or otherwise support a means for selecting a first virtual block from a first plurality of virtual blocks, the first plurality of virtual blocks including the first virtual block and a second virtual block. In some examples, the block selection component 425 may be configured as or otherwise support a means for selecting the second virtual block from the first plurality of virtual blocks based at least in part on first data stored in memory corresponding to the first virtual block satisfying a threshold. The write command transmitter 445 may be configured as or otherwise support a means for transmitting one or more first commands to write second data to memory corresponding to the second virtual block based at least in part on selecting the second virtual block from the first plurality of virtual blocks. In some examples, the block selection component 425 may be configured as or otherwise support a means for selecting a third virtual block from a second plurality of virtual blocks different than the first plurality of virtual blocks. The block erase command transmitter 450 may be configured as or otherwise support a means for transmitting one or more second commands to erase third data stored in memory corresponding to the third virtual block based at least in part on selecting the third virtual block from the second plurality of virtual blocks. In some examples, the open block component 440 may be configured as or otherwise support a means for updating, based at least in part on erasing the third data, the first plurality of virtual blocks to further include the third virtual block.

In some examples, the delay component 455 may be configured as or otherwise support a means for delaying one or more access operations based at least in part on the first data stored in the memory corresponding to the first virtual block satisfying the threshold.

In some examples, the resume component 470 may be configured as or otherwise support a means for resuming the one or more access operations based at least in part on selecting the second virtual block from the first plurality of virtual blocks, where writing the second data to the memory corresponding to the second virtual block is based at least in part on resuming the one or more access operations.

In some examples, the system information component 460 may be configured as or otherwise support a means for flushing system information associated with the second virtual block based at least in part on selecting the second virtual block from the first plurality of virtual blocks.

In some examples, the open block component 440 may be configured as or otherwise support a means for determining a first quantity of virtual blocks for host system write operations. In some examples, the open block component 440 may be configured as or otherwise support a means for determining a second quantity of virtual blocks for garbage collection operations.

In some examples, a third quantity of virtual blocks is greater than a sum of the first quantity of virtual blocks and the second quantity of virtual. In some examples, the first plurality of virtual blocks includes the third quantity of virtual blocks.

In some examples, the described functionality of the system 420, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the system 420, or various components thereof, may be implemented at least in part by instructions (e.g., stored in memory, non-transitory computer-readable medium) executable by such at least one processor.

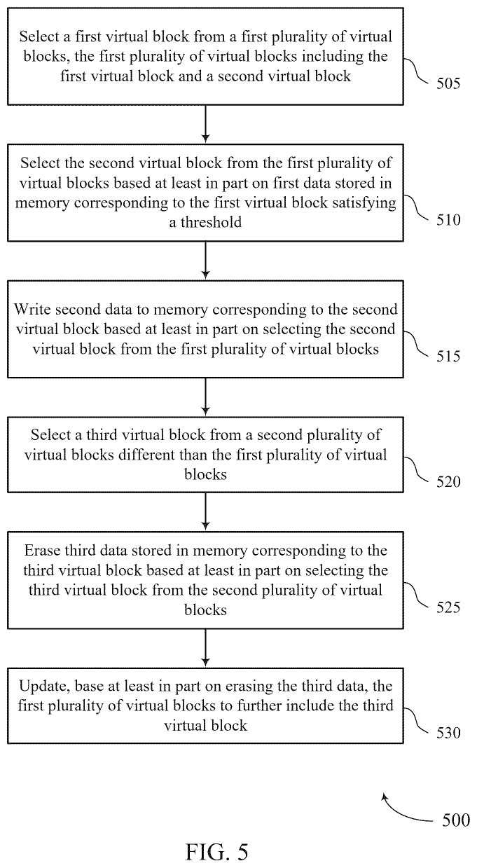

FIG. 5 shows a flowchart illustrating a method 500 that supports a change open virtual block flow for a system in accordance with examples as disclosed herein. The operations of method 500 may be implemented by a system (e.g., a host system or a memory system) or its components as described herein. For example, the operations of method 500 may be performed by a system as described with reference to FIGS. 1 through 4. In some examples, a system may execute a set of instructions to control the functional elements of the device to perform the described functions. Additionally, or alternatively, the system may perform aspects of the described functions using special-purpose hardware.

At 505, the method may include selecting a first virtual block from a first plurality of virtual blocks, the first plurality of virtual blocks including the first virtual block and a second virtual block. In some examples, aspects of the operations of 505 may be performed by a block selection component 425 as described with reference to FIG. 4.

At 510, the method may include selecting the second virtual block from the first plurality of virtual blocks based at least in part on first data stored in memory corresponding to the first virtual block satisfying a threshold. In some examples, aspects of the operations of 510 may be performed by a block selection component 425 as described with reference to FIG. 4.

At 515, the method may include writing second data to memory corresponding to the second virtual block based at least in part on selecting the second virtual block from the first plurality of virtual blocks. In some examples, aspects of the operations of 515 may be performed by a write component 430 as described with reference to FIG. 4.

At 520, the method may include selecting a third virtual block from a second plurality of virtual blocks different than the first plurality of virtual blocks. In some examples, aspects of the operations of 520 may be performed by a block selection component 425 as described with reference to FIG. 4.

At 525, the method may include erasing third data stored in memory corresponding to the third virtual block based at least in part on selecting the third virtual block from the second plurality of virtual blocks. In some examples, aspects of the operations of 525 may be performed by a block erase component 435 as described with reference to FIG. 4.

At 530, the method may include updating, based at least in part on erasing the third data, the first plurality of virtual blocks to further include the third virtual block. In some examples, aspects of the operations of 530 may be performed by an open block component 440 as described with reference to FIG. 4.

In some examples, an apparatus as described herein may perform a method or methods, such as the method 500. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for selecting a first virtual block from a first plurality of virtual blocks, the first plurality of virtual blocks including the first virtual block and a second virtual block; selecting the second virtual block from the first plurality of virtual blocks based at least in part on first data stored in memory corresponding to the first virtual block satisfying a threshold; writing second data to memory corresponding to the second virtual block based at least in part on selecting the second virtual block from the first plurality of virtual blocks; selecting a third virtual block from a second plurality of virtual blocks different than the first plurality of virtual blocks; erasing third data stored in memory corresponding to the third virtual block based at least in part on selecting the third virtual block from the second plurality of virtual blocks; and updating, based at least in part on erasing the third data, the first plurality of virtual blocks to further include the third virtual block.

Aspect 2: The method, apparatus, or non-transitory computer-readable medium of aspect 1, further including operations, features, circuitry, logic, means, or instructions, or any combination thereof for delaying one or more access operations based at least in part on the first data stored in the memory corresponding to the first virtual block satisfying the threshold.

Aspect 3: The method, apparatus, or non-transitory computer-readable medium of aspect 2, further including operations, features, circuitry, logic, means, or instructions, or any combination thereof for resuming the one or more access operations based at least in part on selecting the second virtual block from the first plurality of virtual blocks, where writing the second data to the memory corresponding to the second virtual block is based at least in part on resuming the one or more access operations.

Aspect 4: The method, apparatus, or non-transitory computer-readable medium of any of aspects 1 through 3, where erasing the third data includes operations, features, circuitry, logic, means, or instructions, or any combination thereof for erasing the third data stored in the memory corresponding to the third virtual block during an idle time associated with the system.

Aspect 5: The method, apparatus, or non-transitory computer-readable medium of any of aspects 1 through 4, further including operations, features, circuitry, logic, means, or instructions, or any combination thereof for flushing system information associated with the second virtual block based at least in part on selecting the second virtual block from the first plurality of virtual blocks.

Aspect 6: The method, apparatus, or non-transitory computer-readable medium of any of aspects 1 through 5, further including operations, features, circuitry, logic, means, or instructions, or any combination thereof for flushing parity information associated with the first data to the memory corresponding to the first virtual block based at least in part on the first data stored in the memory corresponding to the first virtual block satisfying the threshold.

Aspect 7: The method, apparatus, or non-transitory computer-readable medium of any of aspects 1 through 6, further including operations, features, circuitry, logic, means, or instructions, or any combination thereof for determining a first quantity of virtual blocks for host system write operations and determining a second quantity of virtual blocks for garbage collection operations.

Aspect 8: The method, apparatus, or non-transitory computer-readable medium of aspect 7, where a third quantity of virtual blocks is greater than a sum of the first quantity of virtual blocks and the second quantity of virtual blocks and the first plurality of virtual blocks includes the third quantity of virtual blocks.

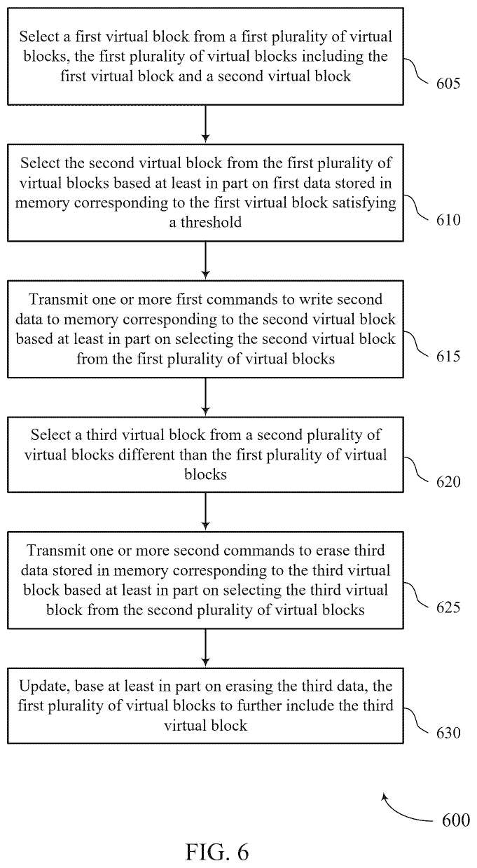

FIG. 6 shows a flowchart illustrating a method 600 that supports a change open virtual block flow for a system in accordance with examples as disclosed herein. The operations of method 600 may be implemented by a host system or its components as described herein. For example, the operations of method 600 may be performed by a host system as described with reference to FIGS. 1 through 4. In some examples, a host system may execute a set of instructions to control the functional elements of the device to perform the described functions. Additionally, or alternatively, the host system may perform aspects of the described functions using special-purpose hardware.

At 605, the method may include selecting a first virtual block from a first plurality of virtual blocks, the first plurality of virtual blocks including the first virtual block and a second virtual block. In some examples, aspects of the operations of 605 may be performed by a block selection component 425 as described with reference to FIG. 4.

At 610, the method may include selecting the second virtual block from the first plurality of virtual blocks based at least in part on first data stored in memory corresponding to the first virtual block satisfying a threshold. In some examples, aspects of the operations of 610 may be performed by a block selection component 425 as described with reference to FIG. 4.

At 615, the method may include transmitting one or more first commands to write second data to memory corresponding to the second virtual block based at least in part on selecting the second virtual block from the first plurality of virtual blocks. In some examples, aspects of the operations of 615 may be performed by a write command transmitter 445 as described with reference to FIG. 4.

At 620, the method may include selecting a third virtual block from a second plurality of virtual blocks different than the first plurality of virtual blocks. In some examples, aspects of the operations of 620 may be performed by a block selection component 425 as described with reference to FIG. 4.

At 625, the method may include transmitting one or more second commands to erase third data stored in memory corresponding to the third virtual block based at least in part on selecting the third virtual block from the second plurality of virtual blocks. In some examples, aspects of the operations of 625 may be performed by a block erase command transmitter 450 as described with reference to FIG. 4.

At 630, the method may include updating, based at least in part on erasing the third data, the first plurality of virtual blocks to further include the third virtual block. In some examples, aspects of the operations of 630 may be performed by an open block component 440 as described with reference to FIG. 4.

In some examples, an apparatus as described herein may perform a method or methods, such as the method 600. The apparatus may include features, circuitry, logic, means, or instructions (e.g., a non-transitory computer-readable medium storing instructions executable by a processor), or any combination thereof for performing the following aspects of the present disclosure:

Aspect 9: A method, apparatus, or non-transitory computer-readable medium including operations, features, circuitry, logic, means, or instructions, or any combination thereof for selecting a first virtual block from a first plurality of virtual blocks, the first plurality of virtual blocks including the first virtual block and a second virtual block; selecting the second virtual block from the first plurality of virtual blocks based at least in part on first data stored in memory corresponding to the first virtual block satisfying a threshold; transmitting one or more first commands to write second data to memory corresponding to the second virtual block based at least in part on selecting the second virtual block from the first plurality of virtual blocks; selecting a third virtual block from a second plurality of virtual blocks different than the first plurality of virtual blocks; transmitting one or more second commands to erase third data stored in memory corresponding to the third virtual block based at least in part on selecting the third virtual block from the second plurality of virtual blocks; and updating, based at least in part on erasing the third data, the first plurality of virtual blocks to further include the third virtual block.

Aspect 10: The method, apparatus, or non-transitory computer-readable medium of aspect 9, further including operations, features, circuitry, logic, means, or instructions, or any combination thereof for delaying one or more access operations based at least in part on the first data stored in the memory corresponding to the first virtual block satisfying the threshold.

Aspect 11: The method, apparatus, or non-transitory computer-readable medium of aspect 10, further including operations, features, circuitry, logic, means, or instructions, or any combination thereof for resuming the one or more access operations based at least in part on selecting the second virtual block from the first plurality of virtual blocks, where writing the second data to the memory corresponding to the second virtual block is based at least in part on resuming the one or more access operations.

Aspect 12: The method, apparatus, or non-transitory computer-readable medium of any of aspects 9 through 11, further including operations, features, circuitry, logic, means, or instructions, or any combination thereof for flushing system information associated with the second virtual block based at least in part on selecting the second virtual block from the first plurality of virtual blocks.

Aspect 13: The method, apparatus, or non-transitory computer-readable medium of any of aspects 9 through 12, further including operations, features, circuitry, logic, means, or instructions, or any combination thereof for determining a first quantity of virtual blocks for host system write operations and determining a second quantity of virtual blocks for garbage collection operations.

Aspect 14: The method, apparatus, or non-transitory computer-readable medium of aspect 13, where a third quantity of virtual blocks is greater than a sum of the first quantity of virtual blocks and the second quantity of virtual and the first plurality of virtual blocks includes the third quantity of virtual blocks.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit in response to the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed, and a second condition or action may at least partially occur as a result of the previous condition or action occurring (whether directly after or after one or more other intermediate conditions or actions occurring after the first condition or action).

Additionally, the terms “directly in response to” or “in direct response to” may refer to one condition or action occurring as a direct result of a previous condition or action. In some examples, a first condition or action may be performed, and a second condition or action may occur directly as a result of the previous condition or action occurring independent of whether other conditions or actions occur. In some examples, a first condition or action may be performed, and a second condition or action may occur directly as a result of the previous condition or action occurring, such that no other intermediate conditions or actions occur between the earlier condition or action and the second condition or action or a limited quantity of one or more intermediate steps or actions occur between the earlier condition or action and the second condition or action. Any condition or action described herein as being performed “based on,” “based at least in part on,” or “in response to” some other step, action, event, or condition may additionally, or alternatively (e.g., in an alternative example), be performed “in direct response to” or “directly in response to” such other condition or action unless otherwise specified.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processing system (e.g., one or more processors, one or more controllers, control circuitry, processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A system, comprising:
processing circuitry associated with one or more memory devices and configured to cause the system to:
select a first virtual block from a first plurality of virtual blocks, the first plurality of virtual blocks comprising the first virtual block and a second virtual block;
select the second virtual block from the first plurality of virtual blocks based at least in part on first data stored in memory corresponding to the first virtual block satisfying a threshold;
write second data to memory corresponding to the second virtual block based at least in part on selecting the second virtual block from the first plurality of virtual blocks;
select a third virtual block from a second plurality of virtual blocks different than the first plurality of virtual blocks;
erase third data stored in memory corresponding to the third virtual block based at least in part on selecting the third virtual block from the second plurality of virtual blocks; and
updating, base at least in part on erasing the third data, the first plurality of virtual blocks to further comprise the third virtual block.

2. The system of claim 1, wherein the processing circuitry is further configured to cause the system to:
delay one or more access operations based at least in part on the first data stored in the memory corresponding to the first virtual block satisfying the threshold.

3. The system of claim 2, wherein the processing circuitry is further configured to cause the system to:
resume the one or more access operations based at least in part on selecting the second virtual block from the first plurality of virtual blocks, wherein writing the second data to the memory corresponding to the second virtual block is based at least in part on resuming the one or more access operations.

4. The system of claim 1, wherein erasing the third data comprises the processing circuitry configured to cause the system to:
erase the third data stored in the memory corresponding to the third virtual block during an idle time associated with the system.

5. The system of claim 1, wherein the processing circuitry is further configured to cause the system to:
flush system information associated with the second virtual block based at least in part on selecting the second virtual block from the first plurality of virtual blocks.

6. The system of claim 1, wherein the processing circuitry is further configured to cause the system to:
flush parity information associated with the first data to the memory corresponding to the first virtual block based at least in part on the first data stored in the memory corresponding to the first virtual block satisfying the threshold.

7. The system of claim 1, wherein the processing circuitry is further configured to cause the system to:
determine a first quantity of virtual blocks for host system write operations; and
determine a second quantity of virtual blocks for garbage collection operations.

8. The system of claim 7, wherein:
a third quantity of virtual blocks is greater than a sum of the first quantity of virtual blocks and the second quantity of virtual blocks, and
the first plurality of virtual blocks comprises the third quantity of virtual blocks.

9. A host system, comprising:
one or more interfaces comprising one or more signal paths operable for communications with one or more memory systems; and
processing circuitry coupled with the one or more interfaces and configured to cause the host system to:
select a first virtual block from a first plurality of virtual blocks, the first plurality of virtual blocks comprising the first virtual block and a second virtual block;
select the second virtual block from the first plurality of virtual blocks based at least in part on first data stored in memory corresponding to the first virtual block satisfying a threshold;
transmit one or more first commands to write second data to memory corresponding to the second virtual block based at least in part on selecting the second virtual block from the first plurality of virtual blocks;
select a third virtual block from a second plurality of virtual blocks different than the first plurality of virtual blocks;
transmit one or more second commands to erase third data stored in memory corresponding to the third virtual block based at least in part on selecting the third virtual block from the second plurality of virtual blocks; and
updating, base at least in part on erasing the third data, the first plurality of virtual blocks to further comprise the third virtual block.

10. The host system of claim 9, wherein the processing circuitry is further configured to cause the host system to:
delay one or more access operations based at least in part on the first data stored in the memory corresponding to the first virtual block satisfying the threshold.

11. The host system of claim 10, wherein the processing circuitry is further configured to cause the host system to:
resume the one or more access operations based at least in part on selecting the second virtual block from the first plurality of virtual blocks, wherein writing the second data to the memory corresponding to the second virtual block is based at least in part on resuming the one or more access operations.

12. The host system of claim 9, wherein the processing circuitry is further configured to cause the host system to:
flush system information associated with the second virtual block based at least in part on selecting the second virtual block from the first plurality of virtual blocks.

13. The host system of claim 9, wherein the processing circuitry is further configured to cause the host system to:
determine a first quantity of virtual blocks for host system write operations; and
determine a second quantity of virtual blocks for garbage collection operations.

14. The host system of claim 13, wherein:
a third quantity of virtual blocks is greater than a sum of the first quantity of virtual blocks and the second quantity of virtual, and
the first plurality of virtual blocks comprises the third quantity of virtual blocks.

15. A method by a system, comprising:
selecting a first virtual block from a first plurality of virtual blocks, the first plurality of virtual blocks comprising the first virtual block and a second virtual block;
selecting the second virtual block from the first plurality of virtual blocks based at least in part on first data stored in memory corresponding to the first virtual block satisfying a threshold;
writing second data to memory corresponding to the second virtual block based at least in part on selecting the second virtual block from the first plurality of virtual blocks;
selecting a third virtual block from a second plurality of virtual blocks different than the first plurality of virtual blocks;
erasing third data stored in memory corresponding to the third virtual block based at least in part on selecting the third virtual block from the second plurality of virtual blocks; and
updating, based at least in part on erasing the third data, the first plurality of virtual blocks to further comprise the third virtual block.

16. The method of claim 15, further comprising:
delaying one or more access operations based at least in part on the first data stored in the memory corresponding to the first virtual block satisfying the threshold.

17. The method of claim 16, further comprising:
resuming the one or more access operations based at least in part on selecting the second virtual block from the first plurality of virtual blocks, wherein writing the second data to the memory corresponding to the second virtual block is based at least in part on resuming the one or more access operations.

18. The method of claim 15, wherein erasing the third data comprises:
erasing the third data stored in the memory corresponding to the third virtual block during an idle time associated with the system.

19. The method of claim 15, further comprising:
flushing system information associated with the second virtual block based at least in part on selecting the second virtual block from the first plurality of virtual blocks.

20. The method of claim 15, further comprising:
flushing parity information associated with the first data to the memory corresponding to the first virtual block based at least in part on the first data stored in the memory corresponding to the first virtual block satisfying the threshold.

21. The method of claim 15, further comprising:
determining a first quantity of virtual blocks for host system write operations; and
determining a second quantity of virtual blocks for garbage collection operations.

22. The method of claim 21, wherein a third quantity of virtual blocks is greater than a sum of the first quantity of virtual blocks and the second quantity of virtual blocks and the first plurality of virtual blocks comprises the third quantity of virtual blocks.
